(19) United States
(12) Patent Application Publication
(10) Pub. No.: US 2011/0137674 A1
(43) Pub. Date: Jun. 9, 2011

(54) APPARATUS AND METHOD FOR VERIFYING PROCEDURE COMPLIANCE

(76) Inventors: Israel BIRENBAUM, Zichron Yaakov (IL); Kevin Rubey, Ventura, CA (US); Gavriel Meron, Petah Tikva (IL)

(21) Appl. No.: 12/951,267

(22) Filed: Nov. 22, 2010

Related U.S. Application Data
(60) Provisional application No. 61/263,085, filed on Nov. 20, 2009.

(51) Int. Cl. G06Q 50/00

(52) U.S. Cl. 705/2

(57) ABSTRACT

A device and method for verifying compliance of a patient to a medical procedure protocol, for example a capsule endoscopy imaging examination. One or more reminders may be issued to the patient to perform an instruction for a colon preparation period or the examination period. Input information related to the procedure and the patient protocol may be received and recorded. Information of activities recorded on the device may be provided for surveying in order to evaluate the readiness of colon preparation or to evaluate compliance with the examination regimen.

### PRIOR APPLICATION DATA

The present application claims priority from U.S. provisional patent application 61/263,085, filed on Nov. 20, 2010, entitled “Apparatus and Method for Verifying Procedure Compliance” incorporated herein in its entirety.

### FIELD OF THE INVENTION

The present invention relates to colonoscopy, capsule endoscopy or other diagnosis. In particular, it relates to compliance verification of colon preparation by a patient before diagnosis.

### BACKGROUND OF THE INVENTION

Colonoscopy and capsule endoscopy diagnosis are medical procedures that may take pictures of, for example, the colon (large intestine) from, for example, the lowest part, the rectum, all the way to the lower end of the small intestine of a patient. The images are displayed on a screen and diagnosed, for example, by a physician to identify possible or potential colon and bowel diseases, including, for example, polyps, diverticulosis, and cancer.

In order to get clear and accurate pictures of the colon, a good pre-diagnosis colon preparation may be needed. The preparation of the colon may take, for example, up to 8 to 24 or more hours during which the patient may be required to follow a certain preparation procedure, or protocol selected or customized by a physician. For example, the patient may be asked to take laxatives or other oral agents at home to clear stools from the colon, and/or drink certain types of fluid, at a series of predetermined time intervals. Such preparation procedures are described, for example, in embodiments of U.S. Patent Application Publication No. 2009/0105537 to Gat et al, which is assigned to the common assignee of the present invention. It is understandable that some patients may not strictly follow the required preparation procedure due to reasons such as, for example, that the patient may be simply absent-minded or forgetful. Furthermore, before performing colonoscopy diagnosis of the patient, the physician may also need to know, aside from any required preparation taken by the patient, what other types of activities the patient had prior to the diagnosis.

### SUMMARY OF THE INVENTION

Embodiments of the present invention provide a device and method for verifying compliance of a patient performing colon preparation prior to a colonoscopy diagnosis. The device and method may include issuing a reminder to the patient to perform an activity for colon preparation; receiving a confirmation responding to the reminder; and recording the confirmation.

According to an embodiment of the invention, the device and method may include issuing one or more subsequent reminders after a pre-selected time period elapses from the time the reminder was issued if the confirmation is not received.

According to an embodiment of the invention, the device and method may also include recording a non-compliance indication if the confirmation is not received by a pre-set time period before a subsequent colon preparation activity becomes due.

According to an embodiment of the invention, the activity for colon preparation may be selected from a pre-defined set of activities; some of the activities may be required for colon preparation; and some of the activities may be required for recordation if performed by the patient.

According to an embodiment of the invention, the device and method may include providing recorded information on activities for evaluating colon preparation.

According to an embodiment of the invention, providing recorded information may include uploading the recorded activities from a recorder to a computer.

According to an embodiment of the invention, the device and system may include selecting a colon preparation protocol for the patient.

According to an embodiment of the invention, selecting the colon preparation protocol may include downloading a pre-defined set of activities to be performed by the patent.

According to an embodiment of the invention, the device may be a portable device, and may be self-contained, and may be operated by a battery.

According to some embodiments of the present invention, there may also be provided a colon preparation recorder comprising: a controller to issue one or more reminders to a patient to perform an activity for colon preparation; a user interface to receive a confirmation responding to the reminders; and a data recording device to record the confirmation.

According to some embodiments, the interface may comprise at least one button for the user to enter the confirmation. The interface may comprise at least one microphone for the user to enter the confirmation verbally. The interface may comprise at least one speaker to alert the user about the activity. The interface may comprise at least one vibration element to alert the user about the activity.

According to some embodiments, the activity is selected from a set of pre-defined activities, and wherein the activity is related to a colon preparation procedure, however other medical examination procedures may be facilitated by embodiments of the present invention, such as capsule endoscopy procedures for imaging the small bowel, the colon or other sections of the GI tract. The interface may comprise at least one screen to display the set of pre-defined activities.

According to some embodiments, there may be provided a method for verifying compliance of patient activity prior to a medical procedure on a patient, the method comprising:

recording one or more activities on a recorder; and
evaluating readiness for the procedure by surveying activities recorded on the recorder.

According to some embodiments, there may be provided a method for verifying compliance of patient activity during a medical procedure and/or prior to it. The method may include configuring a set of numbered instructions for the patient using a software configuration tool; generating an instruction leaflet to the patient, the leaflet including the numbered set of instructions and a corresponding description of each instruction; and displaying a reminder to the patient to perform an instruction, the reminder being displayed as a number on a screen of a colon preparation recorder.

In some embodiments, the method may include receiving from the patient input information through a user interface of the colon preparation recorder; and recording the patient input information. The patient input information may be related to activities of the patient during the preparation period and/or during the medical examination period.

According to some embodiments, the set of instructions may include instructions for a preparation period and/or an examination period.

According to some embodiments, there may also be provided a device for verifying compliance of patient activity prior to a medical procedure on a patient, the device including a unit to prompt a patient to follow a protocol; and a unit to record one or more patient activities.

### BRIEF DESCRIPTION OF THE DRAWINGS

The subject matter regarded as the invention is particularly pointed out and distinctly claimed in the summary of the specification. The invention, however, both as to organization and method of operation, together with objects, features and advantages thereof, may be best understood by reference to the following detailed description when read with the accompanied drawings in which:

FIG. 1A is a schematic illustration of a colon preparation recorder in accordance with an illustrative embodiment of the present invention;

FIG. 1B shows internal modules of the colon preparation recorder of FIG. 1B;

FIG. 2 is a schematic illustration of a patient wearing a colon preparation recorder in accordance with an illustrative embodiment of the present invention;

FIG. 3 is a schematic illustration of a physician downloading from a computer, procedure related protocols for colon preparation to a colon preparation recorder, and/or uploading from the colon preparation recorder an activity record to the computer in accordance with an illustrative embodiment of the present invention;

FIG. 4 is a schematic block diagram illustration of a method for recording activities during a colon preparation period prior to a colonoscopy diagnosis of a patient in accordance with an illustrative embodiment of the present invention;

FIG. 5 shows an illustration of a screen display of a colon preparation recorder according to an embodiment of the present invention;

FIG. 6A shows an exemplary instruction leaflet which may be printed out for a patient according to an embodiment of the present invention;

FIG. 6B shows an exemplary procedure protocol which may be printed out for the patient according to an embodiment of the present invention;

FIGS. 7A and 7B are example screens of a Colon Preparation Readiness Evaluation (CPRE) software tool according to one embodiment of the invention; and

FIG. 8 is a flowchart of a method of verifying compliance of a patient who may be required to perform a set of instructions for a medical examination procedure, according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the following detailed description, numerous specific details are set forth in order to provide a thorough understanding of the present invention. However, it will be understood by those skilled in the art that the present invention may be practiced without these specific details. In other instances, well-known methods, procedures, and components have not been described in detail so as not to obscure the present invention.

Embodiments of the present invention provide a device and a method for verifying compliance of colon preparation prior to a colonoscopy diagnosis of a patient. In other embodiments, the procedure to be performed need not be colonoscopy; methods and devices according to embodiments of the present invention may include verifying compliance of patient activity prior to any other medical procedure or medical examination procedure.

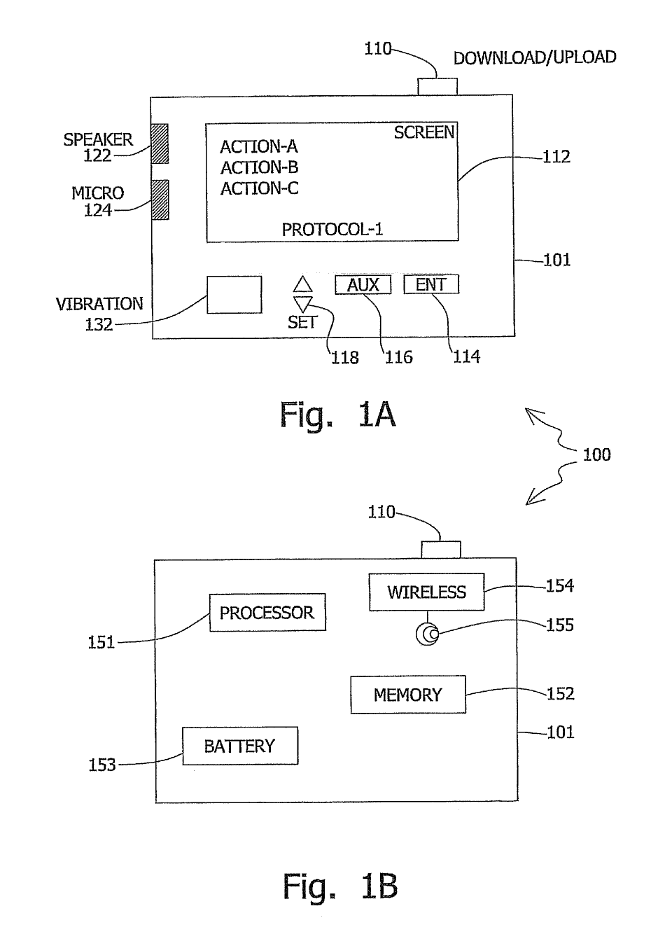

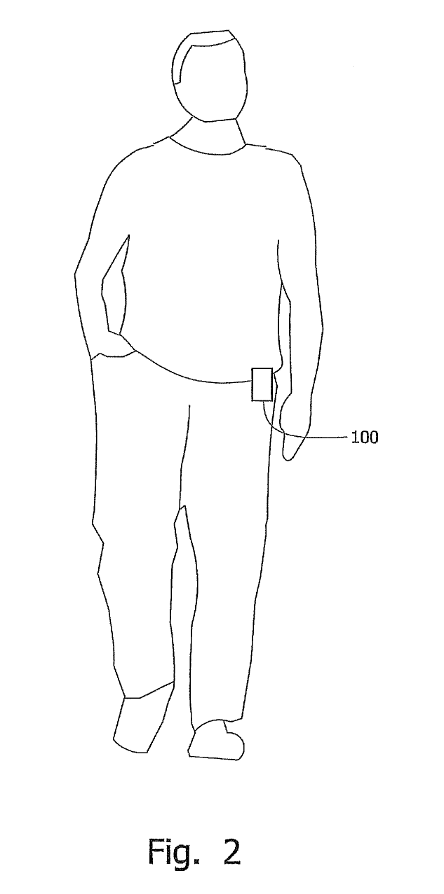

Reference is made to FIGS. 1A and 1B, which are schematic illustrations of a colon preparation recorder (CPR) 100 in accordance with an illustrative embodiment of the present invention.

According to an illustrative embodiment of the invention, CPR 100 may be a portable device and self-contained in a container or case 101. CPR 100 may be similar both in size and in weight to, for example, a wrist-worn watch, a cell phone, and/or a personal digital assistant (PDA). However, the invention is not limited in this respect and CPR 100 may have different sizes and weights from those items identified above.

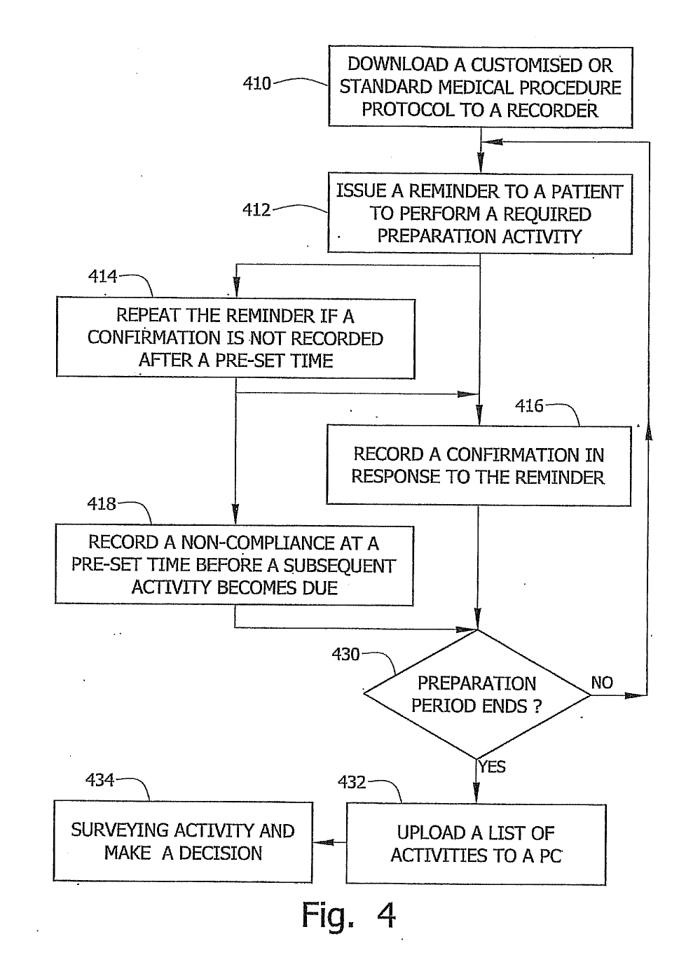

According to an illustrative embodiment of the invention, CPR 100 may have at least one data input/output port, for example, port 110. Port 110 may be used to interconnect with other data processing devices, for example, a personal computer (PC) 310 (see FIG. 3) for downloading and uploading data or information relating to colonoscopy diagnosis and/or other medical procedures. For example, a colon preparation protocol may be downloaded to CPR 100 and activities recorded in CPR 100, which may be entered by a patient during a colon preparation period or during the examination procedure, may be uploaded to the PC 310, as described in detail below with reference to FIG. 3. Port 110 may be for example a USB port, serial port, or other suitable type of data port. In addition, CPR 100 may also include a wireless communication port 154, which may perform the function of data input/output port 110 as described above. Wireless communication port 154 may include, for example, a transceiver and an antenna, e.g., antenna 155.

Computer 310 may include a data processor or controller, and a memory.

CPR 100 may include a data processor 151 and a memory 152. Processor 151 may include a controller able to issue reminders to a patient for performing a colon preparation activity. Processor 151 may also include a recording mechanism or recording device able to record confirmations entered by the patient on a memory 152. Memory 152 may be a Random Access Memory (RAM) or other suitable data storage media, and may be a partially or completely removable and/or pluggable memory device (e.g., a “DiskOnKey®”). CPR 100 may be implemented, for example, as part of a personal digital assistant or other unit, or may be a unit with dedicated functionality. CPR 100 may be battery operated and may include a battery or battery unit 153.

The colon preparation protocol may be printed out for the patient, for example on paper (e.g., as a protocol sheet, leaflet, etc.), using a printer 328 which may be linked to computer 310 or to another device.

According to an illustrative embodiment of the invention, CPR 100 may also include a displaying screen 112 and one or more buttons or controls, for example, enter button 114 (ENT), auxiliary button 116 (AUX), and select button 118 (SEL), as part of an interactive user interface between CPR 100 and a patient who uses CPR 100. Other buttons or input controls may be used. It will be appreciated by a person skilled in the art that screen 112 may also provide one or more touch or controls buttons for data and/or command input by the patient. In addition, CPR 100 may also include a speaker 122 and/or a microphone 124 as part of the interface. Speaker 122 may be used to audibly alert a patient to perform a certain activity following a pre-determined preparation protocol. The patient, after finishing the required activity or simply as a response to the alert, for example, may record a verbal or other audio confirmation to CPR 100 by speaking or making a sound to microphone 124. CPR 100 may additionally include a vibration element 132 (VIB) which may be used to alert the patient, just as screen 112 and/or speaker 122 do, to a certain activity by self-vibration.

It will be appreciated by a person skilled in the art that the present invention may include other interaction or interface components. For example, CPR 100 may use a flashing light to alert the patient to a certain activity.

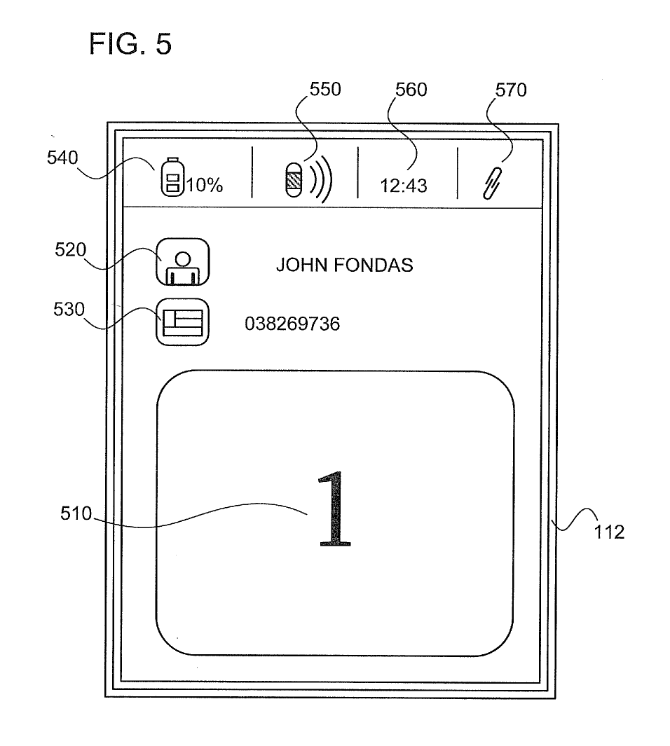

According to an illustrative embodiment of the invention, CPR 100 may also include an internal clock which may record, for example, date and time when an entry is made by a patient or automatically by CPR 100 as described below in detail with reference to FIG. 4. CPR 100 may also send out an alert to the patient based on the time recorded by the internal clock.

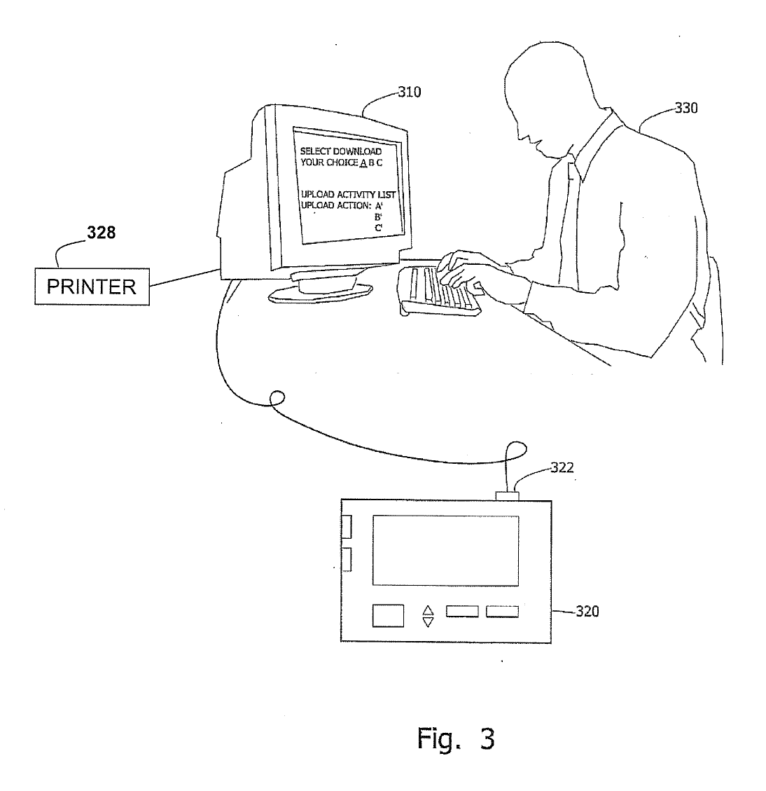

Reference is made to FIG. 2, which is a schematic illustration of a patient wearing a colon preparation recorder (CPR) in accordance with an illustrative embodiment of the present invention. The CPR is shown to be attached to a belt of the patient. However, the invention is not limited in this respect. For example, the CPR may be worn on a wrist or hung on a lanyard around the neck of the patient. Furthermore, the CPR may be put inside a pocket of the clothes that the patient is wearing, or in a bag that the patient is carrying, or located within a vicinity of the patient so long as it can communicate with the patient either audibly, and/or visually, and/or via a vibration signal.

According to one illustrative embodiment, the CPR device for alerting a patient and/or recording patient compliance with preparation procedures may be included in a receiving unit of a capsule endoscope system. For example, the CPR may be incorporated into or attached to a receiver/recorder device that is used to receive and record image data and other data transmitted from a capsule endoscope, as is known in the art. Such a capsule endoscope system may be similar to the system, for example, described in embodiments of U.S. Pat. No. 5,604,531 to Iddan et al and/or U.S. Pat. No. 7,009,634 to Iddan et al, both of which are assigned to the common assignee of the present invention and both of which are incorporated herein by reference in their entirety. Such a capsule endoscope system may be similar to the commercial PillCam® Colon or PillCam® Colon2 capsules and the associated data recorders and RAPID® workstation of the common assignee. According to embodiments of the invention, the receiver/recorder device, having incorporated the CPR device, may be worn on a belt by a patient or carried by the patient in a pouch.

Furthermore, a device for prompting and/or recording patient activities, according to further embodiments of the invention, may be part of, or incorporated into, or attached to other suitable devices or systems, e.g., a cellular phone or other portable devices.

Reference is made to FIG. 3, which is a schematic illustration of a physician 330 downloading from a personal computer 310 procedure related protocols for colon preparation to the colon preparation recorder 100, and/or uploading from the colon preparation recorder activity record to the personal computer 310 in accordance with an illustrative embodiment of the present invention.

According to an illustrative embodiment of the invention, a data processing device, for example, the personal computer (PC) 310, may be connected with the CPR 100. The connection may be made between an input/output port 322 of CPR 320, and a data communication port 312 of PC 310. However, the invention is not limited in this respect, and the connection may be made remotely. In other words, wireless connection maybe made between CPR 100 (via wireless communication port 154 in FIG. 1) and PC 310, and the wireless connection may be made directly or through a wireless network or any other suitable technologies. PC 310 may be a Windows-based PC, and according to an illustrative embodiment of the invention, may be installed with software designed to help a physician verify compliance of colon preparation by a patient. For the convenience of description, the software will be referred to hereinafter as “Colon Preparation Readiness Evaluation (CPRE) software”, or CPRE software. Other types of computers or dedicated workstations may be used to connect to CPR 100 with other types of software.

According to an illustrative embodiment of the invention, physician 330 may select a default colon preparation protocol or one of a list of protocols available from the CPRE software, or may create a customized protocol through the CPRE software. Physician 330 may then download the protocol to CPR 100, and ask a patient to use CPR 100 during a preparation period to record all the activities that may be relevant to a colonoscopy diagnosis or other procedures. According to some embodiments reminders or prompts to a patient may be sent or issued from a remote location, e.g., through cellular or other appropriate technology.

At the end of the colon preparation period but prior to performing the colonoscopy diagnosis, physician 330 may upload activities recorded on CPR 100 to PC 310. Physician 330 may then evaluate, based on the activities recorded in CPR 100 and displayed on the screen of PC 310, whether the patient is ready to proceed to the colonoscopy or other diagnosis.

Reference is now made to FIG. 4, which is a schematic block diagram illustration of a method for recording activities during a colon preparation period prior to a colonoscopy diagnosis of a patient in accordance with an illustrative embodiment of the present invention.

According to one embodiment as indicated at block 410, a physician or a person who helps administrate the colonoscopy diagnosis, for example, a nurse, may select and download a colon preparation protocol from, for example, computer 310 to CPR 100 which is to be carried by a patient during a colon preparation period. The protocol may be a default protocol, or one from a list of standard protocols provided by the CPRE software installed in the computer. The protocol may also be a customized protocol prepared by the physician or nurse specifically for the patient.

According to one embodiment of the invention, the download may be made prior to a patient performing the required preparation procedure. According to another embodiment of the invention, the download and/or any modification to a previously downloaded protocol may be performed while the patient is already in the preparation stage and the download and/or modification may be made through, e.g., a wireless communication network, from a personal computer or workstation of the physician directly to the CPR 100 worn by the patient with or without the awareness the patient.

As indicated at block 412, at one or more pre-determined times which may be dictated by the protocol, the CPR 100 may issue or give the patient a reminder, audibly and/or visually and/or via a vibration signal, to take a required colon preparation activity such as, for example, drinking a prescribed fluid to help clear stools. The required activity may be displayed, for example, on the screen 112, of the CPR 100. However, the invention is not limited in this respect. For example, the reminder may be issued or given to the patient audibly through a speaker, for example, speaker 122, or through a vibration signal generated by a vibration element, for example, vibration element 132. According to one embodiment of the invention, instructions such as, for example, how to perform the activity may also be provided to the patient through the display screen 112.

As indicated at block 414, if a pre-selected time period or interval, for example, 5 minutes, 10 minutes, or 15 minutes, has elapsed and no confirmation of response to the reminder, or confirmation that the activity has been performed, has been received and recorded by the CPR 100, which may be entered by the patient, the CPR 100 may repeat or re-issue the reminder, audibly and/or visually and/or via a vibration signal, to the patient. The types of confirmation may include, for example, that the patient has taken the required activity, or has partially taken the activity, or will not take the activity. Other types of confirmations may also be possible. The CPR 100 may repeat sending or issuing the same reminder, at the same time interval or a different time interval, to alert the patient to take the required activity until a confirmation is recorded or entered, or until a certain time period has expired. Protocols and patient responses (or lack of responses) may be recorded, for example, on memory 152 in the CPR 100. In other embodiments a memory need not be used and patient input may be transmitted online to a remote station and recoded there.

As indicated at block 416, the patient, following the first reminder or one of the subsequent reminders given or issued by the CPR 100, may enter a confirmation to the CPR 100, or to a remote recording device wirelessly via the CPR 100, indicating that the required colon preparation activity has been taken care of. For example, the activity has either been taken or partially taken or ignored. The confirmation may be entered and recorded by the CPR 100 at least by a pre-set time period prior to a subsequent colon preparation activity becomes due.

As indicated at block 418, if no confirmation is recorded by the pre-set time prior to a subsequent colon preparation activity becomes due, the CPR 100 may proceed to record automatically, or send a recordation signal to a remotely located recording device wirelessly, a non-compliance indication with regard to this particular colon preparation activity.

During the colon preparation period, the patient may perform certain activities which are listed in a pre-defined set of activities in the CPR 100. The activity may be required for colon preparation, or may not be required for the purpose of colon preparation but required for recordation so that the physician may become aware of the activity later. For example, a patient may perform an activity prior to the CPR 100 issuing a reminder. After the activity, the patient may record the activity in the CPR 100. The CPR 100 may display a list of activities which are pre-downloaded by the physician during protocol preparation. The patient may review the list of activities on a display, e.g., display 112 of CPR 100, select the activity he/she performed, and enter a confirmation. According to some embodiments of the invention activities, pre-defined or not, may include stopping or starting a certain diet, in-taking a laxative, in-taking certain liquids and other suitable activities for colonoscopy preparation. Other activities may be required or pre-defined for procedures other than colonoscopy.

As indicated at block 430, if the colon preparation period has not expired, the CPR 100 may continue to provide the patient with reminders for taking activities when the activities become due, and the patient may enter confirmation responding to the reminder voluntarily, as indicated above at block 416.

After the colon preparation period has passed, the patient may bring the CPR 100 to the health professional 330. As indicated at block 432, the health professional 330 may upload the list of activities and responses that have been recorded in the CPR 100 to the computer 310 or to a dedicated work station. As indicated at block 434, the physician may survey all the activities taken by the patient, either required or non-required by the colon preparation protocol, and may make an assessment as to whether to proceed further with, for example, the colonoscopy diagnosis or the capsule endoscopy examination. The uploading may be by a data link (e.g., a wired connection between the CPR 100 and the computer 310) or for example by physically transferring a storage device (e.g., DiskOnKey®). Other uploading methods, such as, for example, a direct wireless communication link or a wireless link through an existing wireless network may be used.

According to one embodiment of the invention, the physician need not upload the recorded activities, and may survey the recorded activities through the display screen, for example, screen 112, of the CPR and make an appropriate medical judgment regarding further diagnosis.

A CPR (e.g. CPR 100) according to embodiments of the invention may be used by patients preparing for an examination, for example a capsule endoscopy procedure performed using an ingestible imaging capsule. The imaging procedures may include colon imaging and/or other organ imaging, e.g. small bowel, stomach, etc. In such examination procedures, for example colon imaging procedures or small bowel imaging procedures, the CPR may also be used to alert the patient to perform activities during the procedure according to a predetermined regimen or protocol. For example, a specific set of instructions or list of activities which may include, for example, a predetermined diet regimen or a medication schedule, may be provided or displayed (e.g., on display screen 112) to the patient after ingestion of the swallowable capsule. The colon preparation recorder may be programmed, for example by downloading a specific set of instructions from a computer (e.g. computer 310) to the colon preparation recorder prior to the procedure, to alert the patient for preparation instructions prior to the capsule ingestion. Another set of instructions or a different portion of the set may be provide or displayed to alert the patient to perform certain activities during the imaging procedure, for example after the imaging capsule has been ingested. In some embodiments, the physician may change the predefined list of activities before and/or after it has been downloaded to the colon preparation recorder, in order to customize and accommodate it for a specific patient.

In some embodiments, CPR 100 may be included in, or integrated with, a data receiver/recorder which may be used to receive image data and other data which is sent from the imaging capsule during the capsule endoscopy procedure. CPR 100 may include functionality of, for example, receiver 112 in FIG. 1 in U.S. Patent Application Publication Number 2009/0274347 titled “SYSTEM AND METHODS FOR DETERMINATION OF PROCEDURE TERMINATION”, which is incorporated herein by reference. CPR 100 may include a screen (e.g. screen 112 in FIG. 1 of this Application), for example an LCD screen, which may be used both to alert the patient and, for example, to view images received by the CPR functioning also as a data receiver/recorder for the information captured by the examination device (e.g. capsule endoscope). CPR 100 may include user interface such as buttons, keys or touch-screen, to accept information which may be input by the patient or by the physician. In some embodiments, during the procedure preparation period, CPR 100 may function as a colon preparation recorder, and issue reminders for the patient to perform a predetermined procedure protocol.

During the capsule imaging procedure, CPR 100 may function both as a data recorder to receive and store image and other data sent from the imaging capsule, and as a reminder/alert unit to alert the patient according to the procedure protocol. In some embodiments, during the preparation period, CPR 100 may switch to a standby mode, e.g. in order to save battery energy, and may ‘wake up’ from the standby mode when an activity should be alerted to the patient, or upon the patient's demand. For example, when the patient provides input data to the colon preparation recorder, e.g. presses a button or enters data through an available user interface mechanism, the CPR 100 may switch from the standby mode to an operational mode. In another example, the patient or physician may wish to review the complete list of preparation instructions or procedure instructions before or during the examination procedure, or perform a self test of CPR 100, or view real time images during the imaging procedure. These actions may be performed while the colon preparation recorder is issuing the reminders to the patient, and/or while the user is inputting his/her response (compliance) into the colon preparation recorder.

In some embodiments, CPR 100 may be used for patient alerts only during the imaging procedure, for example after ingestion of an imaging capsule, for alerting the patient regarding post-ingestion activities/instructions. In such embodiments, the pre-ingestion phase (e.g., the colon preparation period) may be performed by the patient using a patient instruction paper printout (e.g., a leaflet) instead of receiving alerts from CPR 100. In other embodiments, a patient may use the colon preparation recorder both during the preparation period and during the examination procedure.

In some embodiments, the patient may record different types of activities using the data preparation recorder, for example during the preparation period (pre-ingestion) or during the imaging procedure (post-ingestion). For example, during the preparation period the patient may record activities such as stopping or starting a certain diet, in-taking a laxative or in-taking certain liquids. During the examination procedure, the patient may record activities such as sleeping, eating, drinking, feeling pain, or any other data which may be relevant to the imaging procedure. CPR 100 may alert the patient during the examination procedure with regard to, for example, the procedure phase or the capsule's current location in the body. Certain landmarks such as esophagus, stomach, duodenum, small bowel, cecum, transverse colon, etc. may be reported to the patient when the imaging capsule reaches these landmarks while it traverses the gastrointestinal tract. The landmarks may be detected, for example, based on automatic analysis of the recorded images using image processing methods, or other methods, for example as disclosed in U.S. Patent Application Publication Number 2006/0069317, titled “SYSTEM AND METHOD TO DETECT TRANSITION IN AN IMAGE STREAM”, which is assigned to the common assignee of the present application and which is incorporated herein by reference. In some embodiments, CPR 100 may alert the patient, for example in real time (e.g., during the procedure) that a certain landmark has been detected by analysis of images or other data received by the data recorder from the capsule. Other landmarks may be detected and reported. Such alerts may be beneficial, and may affect the schedule of the reminders/alerts issued by the colon preparation recorder during the rest of the procedure. CPR 100 may also alert the patient when the procedure has terminated, for example as described in U.S. Patent Application Publication Number 2009/0274347, titled “SYSTEM AND METHODS FOR DETERMINATION OF PROCEDURE TERMINATION”, assigned to the common assignee of the present application and which is incorporated herein by reference.

According to some embodiments of the invention, it may be advantageous to simplify the list of activities which is displayed to the patient on the colon preparation recorder. For example, the displayed list may include icons or animations for communicating the current activity required to the user, instead of or in addition to printed text which may be displayed on screen 112 of CPR 100. In some embodiments, it may be easier to reduce the amount of written text which is displayed on screen 112, for example in order to avoid the need to translate the text to the local language in every country, and thereby to avoid language barriers in certain countries or to avoid the need to configure CPR 100 to display output in several alternative languages.

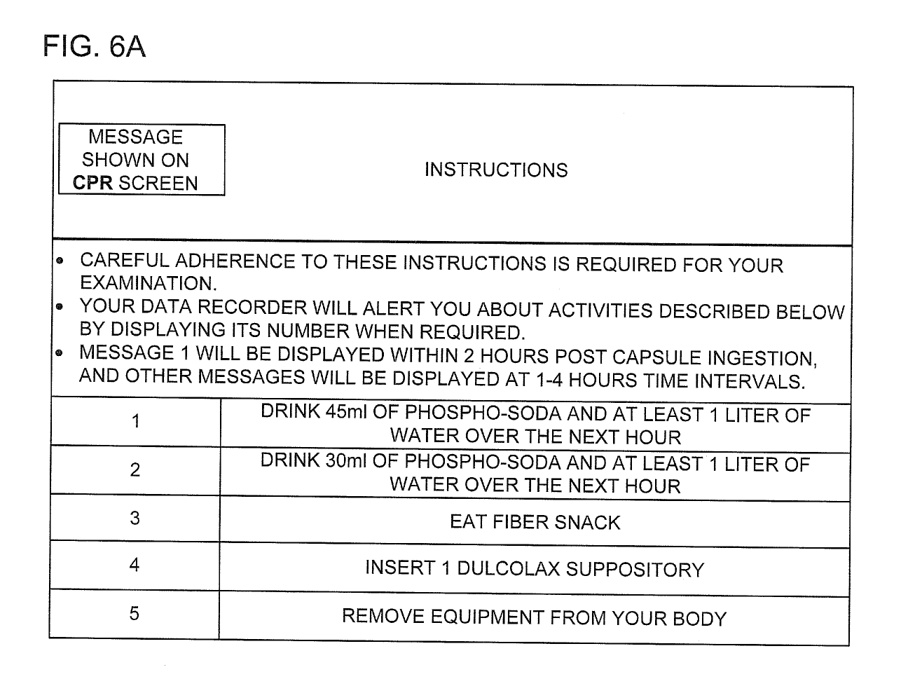

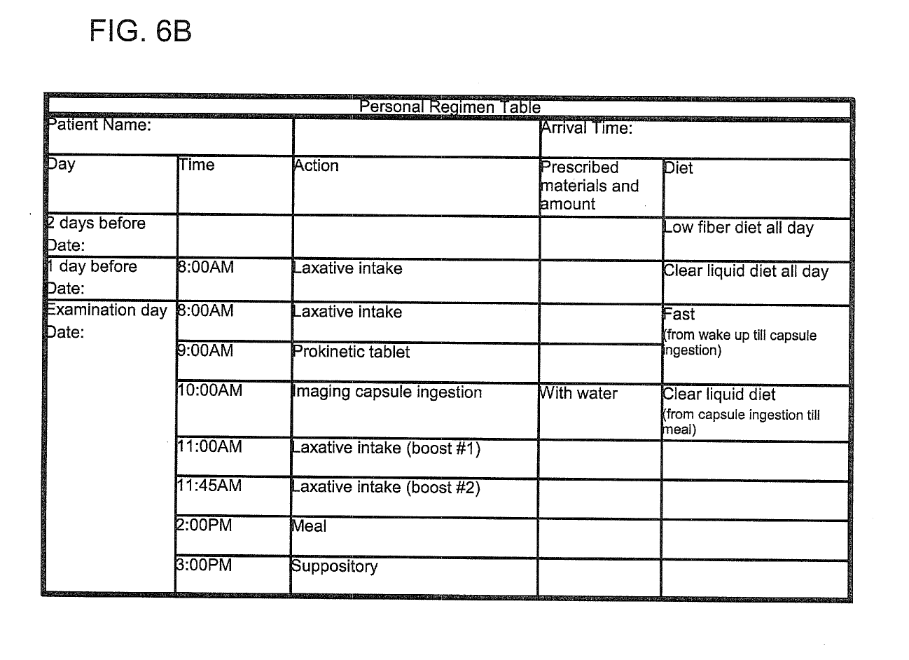

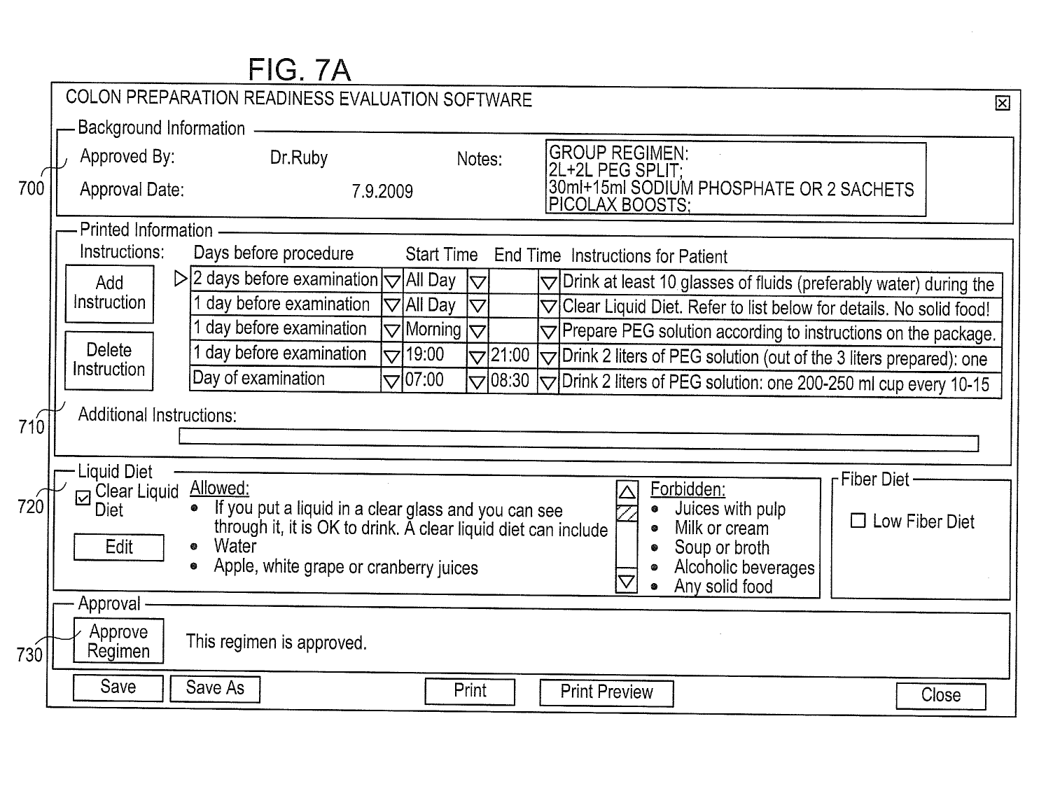

Reference is now made to FIG. 5, which shows an illustration of a screen display 112 of a CPR according to an embodiment of the present invention. The instruction or alert may be presented to the patient on display area 510, and may be represented by a single numerical character corresponding to an instruction listed in an instructed sheet as described herein below. Screen 112 may include other information such as: patient name 520 and ID 530, remaining power in the CPR battery 540, an indication of the quality of the communication channel between the recorder and the imaging capsule 550, the current time 560, indication of association between the imaging capsule to the recorder 570, and other relevant data which may be displayed on the screen of CPR 100, e.g. the patient's initials that, for example, were entered into computer 310 and later uploaded to the CPR during a CPR initialization process. A detailed text description of the activity that corresponds to each numerical character which is displayed on display area 510 of screen 112 may be provided to the patient, for example prior to the preparation procedure or prior to the examination procedure, in a printed leaflet format (for example as shown in FIG. 6A). In other embodiments, the CPR may display the activity to be performed using the local spoken language or a language selected by the patient or doctor. In some embodiments, alphanumerical characters may be used, and/or other characters, icons, animations, etc. The CPR may display the last instruction until the next instruction is updated, or for a limited time period, for example 1 minute. The CPR may display the previous instruction or the next instruction upon user request, for example if the patient presses a button of the recorder/CPR.

FIG. 6A shows an exemplary instruction leaflet which may be printed out for the patient, for example prior to the capsule ingestion. Each activity may have a unique number which will pop up or be displayed on the screen of CPR 100. A detailed description of each numbered instruction is shown on the instruction leaflet, next to the corresponding numerical character. The text description may be easily translated to any local language spoken by the patient in a specific country, and a customized leaflet may be generated per required language, thus eliminating the need for language translation of text displayed on screen 112. The printed leaflet may be folded, for example so as to fit into the patient's pocket, to allow the patient to easily carry the leaflet and refer to it whenever an alert is issued by the colon preparation recorder. A template for the printed leaflet may be provided by the CPRE software and the physician may edit it, for example adding the clinic's logo, adding instructions (dietary and other), adding the patient information, and save the personalized version for later use. The instruction leaflet may include the post-ingestion protocol, to be used in conjunction with the numerical display on the screen of CPR 100.

FIG. 6B shows an exemplary regimen table (or procedure protocol) which may be printed out for the patient, for example for use during the preparation period of a colon capsule imaging procedure, or during the examination procedure, or both (e.g., the pre-ingestion protocol or the complete protocol including both pre-ingestion and post-ingestion instructions). The regimen table for the patient may include the relevant diet which the patient must follow in order to be ready on the day of the procedure. The regimen table may include instructions/activities for several days of preparation by the patient, which may or may not require the patient to record once completed. The list of activities may be divided into different sections, for example one section of activities to be performed prior to the capsule ingestion, and another section which may list the activities to be performed after the ingestion of the imaging capsule. The regimen table may be generated using a CPRE software tool, and may be configured or personalized by the physician per patient or per group of patients. The physician may change the time intervals between reminders, set the list of instructions for the patient, add notes, instructions and patient information to the predefined template.

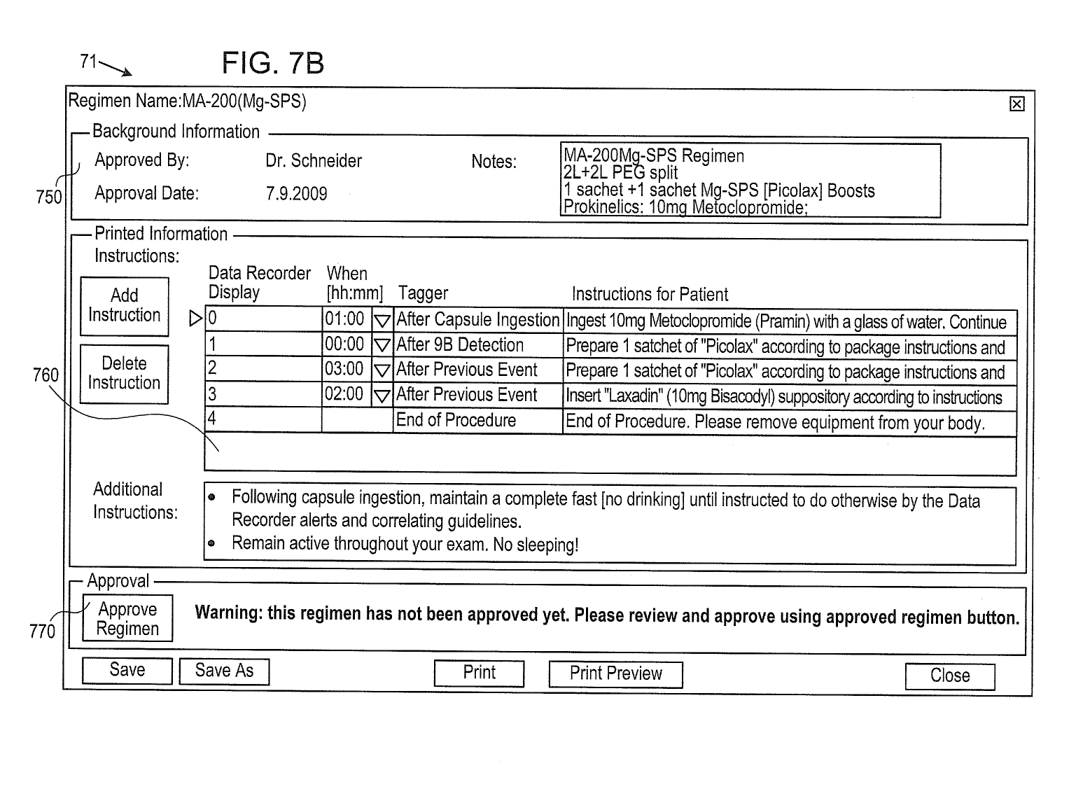

FIGS. 7A and 7B are example screens of a CPRE configuration and management software tool according to one embodiment of the invention. In FIG. 7A, a configuration screen 70 for a capsule endoscopy procedure illustrates an interface for generating a pre-ingestion patient regimen table. Section 710 shows a predefined protocol which includes a list of activities to be performed by the patient before ingesting the capsule, and the time schedule of each activity. The CPRE software may allow the physician or health care specialist to manage, configure and customize a specific activity list or set of instructions for each patient, or to generate a list from a set of predefined available activities or sub-lists. For example, the set of instructions or activity list may be predefined or configured for a specific group of patients (e.g., males over the age of 60) or for patients undergoing a specific type of imaging procedure (e.g., a colon imaging procedure). The CPRE software enables customizing and personalizing the procedure regimen, and thereby enables optimizing the cleanliness of the gastrointestinal tract during the imaging procedure according to the specific requirements of the procedure. The CPRE software may require approval of the set of activities by an authorized specialist, for example as shown in screen section 700 and 730. The CPRE software may include section 710 listing the set of instructions for the patient starting a predetermined time frame prior to the beginning of the imaging procedure, for example 2 days in advance. For example, each instruction may include also the start and end time of the activity and/or the part of the day in which the activity may take place and the text of the instruction to the patient. A section 720 may include a list of the allowed foods and the forbidden foods in the dietary regimen which a patient should follow during the procedure preparation period. In the screen shown in FIG. 7B, a custom set of activities may be configured, for example using drop-down list of pre-defined instructions/activities.

In FIG. 7B, a configuration screen for a capsule endoscopy procedure is shown. Screen 71 includes an interface for generating a post-ingestion patient regimen table, which may be used during the imaging procedure. After the patient has ingested the capsule and in order to ensure a successful procedure, he or she must carefully adhere to the personalized Post-Capsule Ingestion Instructions. During check-in, the recorder may be programmed for these same instructions so that at the predetermined instructions times, the recorder issues the reminder e.g., beeps and vibrates and displays a number. Each number corresponds to an instruction in the post-ingestion patient instructions print-out supplied to the patient. The regimen may be edited and saved for later use. When editing the instruction list, a drop down menu displaying all the post-ingestion regimens available may be displayed, to allow easy selection of a predefined procedure regimen. Similar to the pre-ingestion configuration shown in FIG. 7A, screen sections 750 and 770 may require approval of a physician in order to enable the regimen for use.

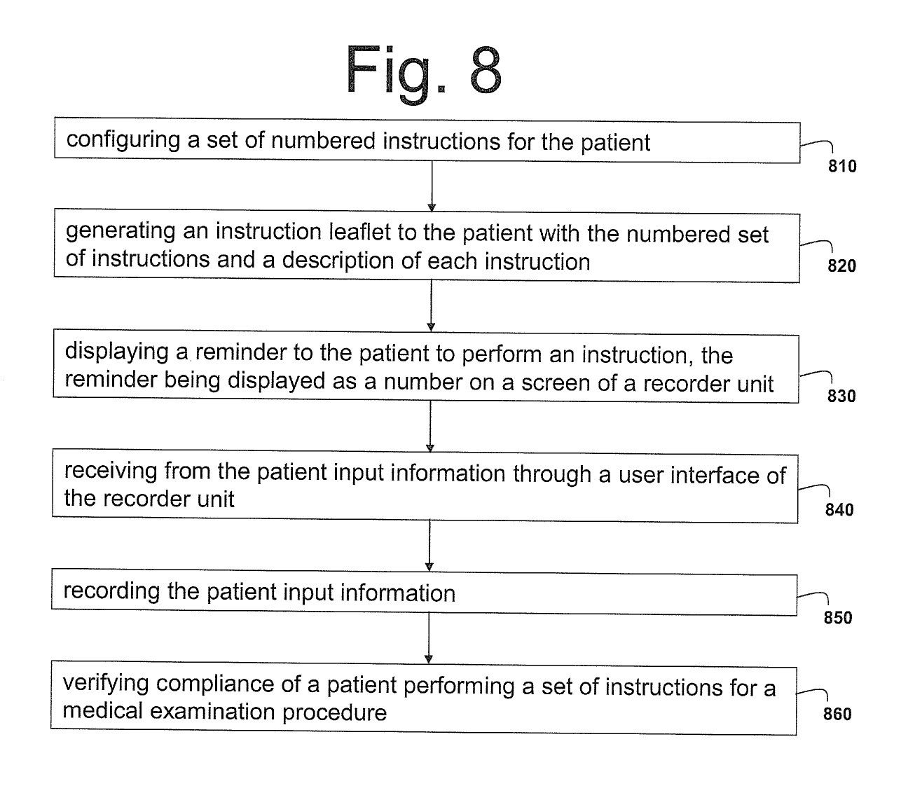

Reference is now made to FIG. 8, which is a flowchart of a method of verifying compliance of a patient who may be required to perform a set of instructions for a medical examination procedure, according to an embodiment of the present invention. Step 810 includes configuring a set of numbered instructions for the patient, for example by using a software configuration such as the CPRE described hereinabove. The configuration may be done for example by a doctor or nurse, or other healthcare specialist. The set of instructions may include instructions that are directed to preparation for a medical procedure, and/or a set of instructions which may be required to be performed by the patient during the examination procedure, for example pre-ingestion instructions and post-ingestion instructions in a capsule endoscopy examination procedure. The set of instructions may preferably include numbered instructions and their corresponding description for the patient, for example as shown in FIG. 6A hereinabove.

In step 820 an instruction leaflet or other printout may be generated, for example printed out using printer 328 which may be connected to, for example, computer 310 or directly to CPR 100 through one of the available connections ports (e.g., port 110, port 154, or another type of communication port which may be used to connect to CPR 100 such as a Bluetooth connection port). The instruction leaflet may include the list of activities/instructions to be performed by the patient and the specific numbers corresponding to these instructions as will be displayed on screen 112 of CPR 100. In addition, the time schedule corresponding to each activity may be printed, as well as additional notes or details which the physician may wish to add, the patient's identification details, etc. The leaflet may be kept and used for reference by the patient during the examination period, and/or during the examination preparation period.

Step 830 includes displaying a reminder to the patient to perform an instruction, for example from the set of instructions that have previously been configured for the patient. The reminder may be displayed as a number on screen 112 of CPR 100. In addition, the CPR may beep, vibrate, or issue other types of reminders in order to alert the patient that an activity must be performed.

Step 840 includes receiving from the patient input information. Such information may include, but is not limited to, compliance information regarding an activity that the patient needs to perform, for example whether the instruction was performed (in a timely manner according to the predefined activity schedule) or not in response to the reminders. Other patient input information may include recording patient's normal activities such as eating, drinking and sleeping. Patients may input information regarding feeling certain pain. The information may be input by the patient through a user interface of CPR 100, e.g. buttons or keys 114, 116 and 118, or for example using a touch-screen which may be included in screen 112 of the CPR. In some embodiments, input information may include vocally recorded data.

In step 850 the patient input information may be received and recorded by CPR 100, for example using memory 152 or a separate storage unit which may be included in CPR 100. In some embodiments, the input information may be transmitted to an external recording unit or to a computer (e.g. PC 310) or workstation that are remote from the CPR. Based on the input information recorded, the compliance of the patient to the preparation and/or the examination procedure may be determined, for example automatically or semi-automatically by CPRE software tool, or manually by a physician or nurse.

According to some embodiments of the invention a prompting and/or recording device as described above may be used in other typically medical or preparatory procedures, such as by pre-labor patients to record the progression of contractions prior to arriving at a hospital for delivery, or by patients required to take numerous pills periodically, etc. By using a device according to embodiments of the invention a patient may record (with or without being prompted) activities or occurrences over a period of time for a physician's review at a later time.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

1. A method for verifying compliance of a patient performing a set of instructions for a medical examination procedure, the method comprising:
configuring a set of numbered instructions for the patient using a software configuration tool;
generating an instruction leaflet to the patient, the leaflet including the numbered set of instructions and a corresponding description of each instruction;
displaying a reminder to the patient to perform an instruction, the reminder being displayed as a number on a screen of a colon preparation recorder;
receiving from the patient input information through a user interface of the colon preparation recorder; and
recording the patient input information.

2. The method of claim 1, wherein the set of instructions includes instructions for a preparation period.

3. The method of claim 2, wherein the patient input information is related to activities of the patient during the preparation period.

4. The method of claim 1, wherein the set of instructions includes instructions for an examination period.

5. The method of claim 3, wherein the patient input information is related to activities of the patient during the examination period.

6. The method of claim 1, comprising uploading recorded information from the colon preparation recorder to a computer.

8. The method of claim 1, further comprising:
determining a procedure protocol for the patient.

9. A colon preparation recorder for verifying compliance of a patient to a medical procedure protocol, the recorder comprising:
a controller to issue one or more reminders to a patient to perform an instruction according to the medical procedure protocol;
a screen to display at least the reminder to the patient in a numerical format;
a user interface to receive input information from the patient; and
a storage device to record the input information.

10. The recorder of claim 9, wherein the interface comprises at least one button for the patient to enter the input information.

11. The recorder of claim 9, wherein the interface comprises at least one microphone for the patient to enter a verbal response to the one or more reminders.

12. The recorder of claim 9, wherein said interface comprises at least one speaker to alert the patient about the instruction.

13. The recorder of claim 9, wherein said interface comprises at least one vibration element to alert the patient about the instruction.

14. The recorder of claim 9, wherein the instruction is selected from a set of pre-defined instructions.

15. The recorder of claim 9, wherein the recorder is included in a receiving unit of a capsule endoscope system.
